(19) United States
(12) Patent Application Publication
(10) Pub. No.: US 2025/0245691 A1
(43) Pub. Date: Jul. 31, 2025

(54) SYSTEM AND METHOD FOR EMBODIED EMOTIONS MAPPING AND ANALYSIS

(71) Applicants: Richard Gillingwater, Oxfordshire (GB); Arkadiy I. Rozental, Owings Mills, MD (US)

(72) Inventors: Richard Gillingwater, Oxfordshire (GB); Arkadiy I. Rozental, Owings Mills, MD (US)

(21) Appl. No.: 19/037,944

(22) Filed: Jan. 27, 2025

Related U.S. Application Data
(60) Provisional application No. 63/625,462, filed on Jan. 26, 2024.
(60) Provisional application No. 63/671,962, filed on Jul. 16, 2024.

(51) Int. Cl. G06Q 30/0242

(52) U.S. Cl. CPC G06Q 30/0242

(57) ABSTRACT

An automated system and method for embodied emotions mapping and prediction of the outcomes of brand imagery using natural- and artificial-intelligence. The present system begins with an archetypal palette comprising a matrix array of twelve core psychological archetypes (e.g., magician, explorer, jester, etc.) each weighted by four persona, set against a matrix of fourteen human motivational needs. The archetypal palette allows a company to translate feelings into visuals and vice versa based on the archetypes, tendencies and embodied emotions they seek to evoke. This allows them to design a brand that is aligned with “embodied emotions” that appeal to the target audiences. Given an established embodied emotion palette, the present system combines a database of brand metrics, and applies a predictive engine to strategically and creatively position, design, evolve and manage brands. The invention includes a method for translating results from other personality assessment models using a translation cross-map.

### CROSS-REFERENCE TO RELATED APPLICATION(S)

The present application derives priority from U.S. Provisional Patent Application 63/625,462 filed 26 Jan. 2024, and derives priority from U.S. Provisional Patent Application 63/671,962 filed 17 Jul. 2024.

### BACKGROUND OF THE INVENTION

### 1. Field of the Invention

The present invention relates generally to brand marketing and, more particularly, to an automated system and method for embodied emotions mapping and analysis.

### 2. Description of the Background

Jungian archetypes provide discrete symbolic representations of human traits that collectively comprise a personality, e.g., the warrior, the wise old man, the mother, the child, etc. Our archetypes drive our actions, decisions, thoughts, and behavior. See, e.g., Margaret Hartwell and Joshua C. Chen, Archetypes in Branding (2012). This book describes twelve archetype families: the Maverick, the Jester, the Lover, the Nurturer, the Regular Guy, the Innocent, the Ruler, the Sage, the Magician, the Hero, the Creator and the Explorer. Each family has five archetypes within it, for a total of sixty established archetypes. The concept of Jungian archetypes has been widely applied for personality and aptitude assessment in the workplace to foster collaboration.

For example, the Myers-Briggs Type Indicator (MBTI) questionnaire assigns a binary value to each of four categories: introversion or extraversion, sensing or intuition, thinking or feeling, and judging or perceiving. The results are mapped to sixteen different “psychological types.” The MBTI inventory has become one of the world's most widely used psychological instruments.

The DiSC® Personal Assessment focuses on four dominant behavior types: Dominance; Influence; Steadiness; and Conscientiousness.

The Predictive Index® Assessment is a two-part test, one that tests cognitive ability and one that tests four behavioral drives: Dominance; Extraversion; Patience; and Formality. The result provides a tool that employers can use to understand the prospective employee's personality and if they're a right fit for the position.

The Kolbe A Index measures instinctive ways one takes action.

All of the foregoing assessment tools adapt the concept of Jungian archetypes for personality and aptitude assessment, and all are widely used by human resource professionals. More recently, the use of personality testing has become a potent marketing technique, giving marketers insightful knowledge of their customer's preferences, motivations, and actions. Companies undertake brand marketing to promote the buying or selling of their products or services. However, humans are driven by a complex mix of emotions. This makes “brand tracking”, e,g., the measurement of customer relationships with a company and its brands, very difficult. Jungian archetypes are also used in marketing; they allow companies to target their advertisements to one or more archetypes. Because archetypes trigger instinctive responses in humans, they provide a vehicle for brands to tell their stories in a form that everyone recognizes and responds to instantly, predictively, and consistently. Thus, when used effectively archetypes improve brand recognition, brand preference, and propensity to buy.

Unfortunately, all known approaches to implement these concepts are highly subjective guesswork or trial-and-error. There is no known analytical approach for solicitation—actual or predicted—of human reactions, or “embodied emotions” that combines a qualitative framework of archetypes with a quantitative analytical model for more accurate brand tracking to help users strategically and creatively position, design, evolve and manage their brands.

What is needed is a system and a method for predicting emotional response to brand imagery by combining a qualitative framework of archetypes with a quantitative analytical model for more accurate brand tracking; to help users strategically and creatively position, design, evolve and manage their brands. Such a system would assist in providing accuracy, efficiency and objectivity to the creative process underlying the design of a brand. Also needed is an ancillary system and a method for translating the results of other personality assessment tools into said qualitative framework of archetypes, and vice versa, so that the quantitative analytical model can be used cross-platform.

### SUMMARY OF THE INVENTION

An automated system and method for embodied emotions mapping and prediction of the outcomes of brand imagery using natural- and artificial-intelligence. The present system begins with an archetypal palette comprising a matrix array of twelve core psychological archetypes (e.g., magician, explorer, jester, etc.) each weighted by four persona, set against a matrix of fourteen human motivational needs. The archetypal palette allows a company to translate feelings into visuals and visuals into feelings based on the archetypes, tendencies and ‘embodied emotions” they seek to evoke. This allows them to design a brand that is aligned with “embodied emotions” that appeal to the target audiences. Given an established embodied emotion palette, the present system combines a global database of brand metrics, and applies a predictive engine to help users strategically and creatively position, design, evolve and manage their brands.

In recognition that there are many other human profiling models that correlate to some extent, the present invention also provides a mapping translation process for translating results between any personality assessment model and its visual manifestation, into the foregoing qualitative framework of archetypes. Such a system assists in providing accuracy, efficiency and objectivity to the creative process underlying the design of a brand marketing campaign.

The combination of the method for quantitatively mapping brand imagery to an archetypal palette by scoring embodied emotions sought to be evoked in a brand-related image using intensity values allows employers to take high-performing employee personality profiles (human resource, sales, business development, consultant, etc.), translate them into embodied emotions that they are soliciting as part of how they motivate others to take desirable actions, and then use the result in outward-facing materials (company website, LinkedIn® profiles, presentation decks, etc.) even when these high performers are not physically present to accomplish the same goals.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is an archetypal palette comprising a matrix array of twelve fundamental archetypes for fictional characters.

FIG. 2 shows a brand map for a company that seeks to project “Pride in our purpose, people, skill and ingenuity.”

FIG. 3 shows a brand map for a company that seeks to project “Go for it—performance & Confidence.”

FIG. 4 shows a brand map for a company that seeks to project “Clever, amazing, confident engineering ingenuity.”

FIG. 5 shows an example of mapping the DISC model to the Brand Palette using a translation cross-map with assigned intensity values, cross-mapping every weighted categorical key quality to the archetypes of Applicant's brand palette.

FIG. 6 illustrates a comprehensive mapping of each DiSC personality type within the DISC model to categorical key qualities.

FIG. 7 shows an example of mapping the Predictive Index (PI) model to the Brand Palette using a translation cross-map of the PI model to categorical key qualities, assigning intensity values, and cross-mapping every weighted categorical key quality to the archetypes of Applicant's brand palette.

FIG. 8 illustrates a comprehensive mapping of each PI reference profile to categorical key qualities.

### DETAILED DESCRIPTION OF THE PREFERRED EMBODIMENT

Applicant's invention is a system and method for imagery-based mapping of embodied emotions, both actual and predicted, using natural- and artificial-intelligence.

“Archetype” is herein defined as a symbol or character that serves as template example or original model from which others are represented.

“Jungian archetypes” are archetypes representing aspects of human behavior or patterns of thought.

An “Archetypal Palette” is a set of archetypes.

An “Archetypal Palette of Characters” refers to a set of character types each with distinct traits or motivations by which human behavior or patterns of thought can be represented.

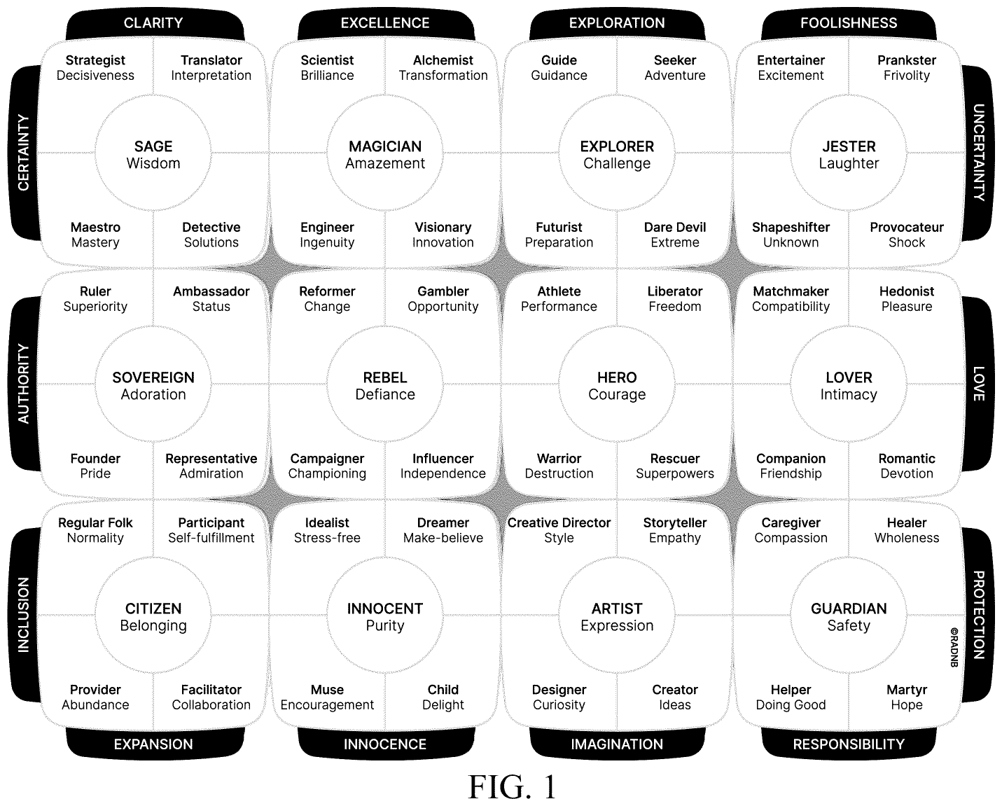

The present system relies on an Archetypal Palette of Characters each associated with a primary “motivational need” or embodied emotion. As seen in FIG. 1, a preferred Archetypal Palette of Characters comprises a matrix array of twelve fundamental archetypes for fictional characters, each fundamental archetype being associated with a motivational need/embodied emotion. Thus, one fundamental archetype, the Sage (top left), is associated with wisdom. The Magician is associated with amazement. The Explorer is associated with challenge. The Jester is associated with laughter. The Sovereign is associated with adoration. The Rebel is associated with defiance. The Hero is associated with courage. The Lover is associated with intimacy. The Citizen is associated with belonging. The Innocent is associated with purity. The Artist is associated with expression. The Guardian is associated with safety. These twelve archetypes are represented in labeled circles arrayed on a matrix of three rows and four columns. The 3×4 archetypes matrix depicts three main categories of “embodied emotions” and their associated dichotomies:

Existence needs: certainty (i.e., the need for safety, stability, and control) vs. uncertainty (i.e., the need for the unknown, change, and surprise).

Relatedness needs: significance and status (the need to have meaning, importance, and being wanted) vs. love and connection (the need for attachment, intimacy, and connection).

Growth needs: growth (the need for personal development) vs. contribution (the need to help, serve, and support others).

The areas around each of the twelve main archetypes are divided into quadrants representing a family of four archetypal variations. Thus, the Magician archetypal family includes four nuanced variations: Alchemist; Engineer; Visionary; Scientist. The Hero archetypal family includes four nuanced variations: Athlete; Liberator; Rescuer; Warrior. The net result is a full group of sixty embodied emotions.

Each main archetype is identified by its primary embodied emotion (motivational need) as described above, and each of its related family of four sub-archetypes is likewise identified by a secondary embodied emotion. Thus, the Magician archetypal family is associated with the primary embodied emotion of “Amazement”, and each of its nuanced variations is likewise associated with a secondary embodied emotion of Alchemist (“Transformation”); Engineer (“Ingenuity”); Scientist (“Brilliance”), and Visionary (“Innovation”). The Hero archetypal family is associated with the primary embodied emotion of “Courage”, and each of its four nuanced variations is likewise associated with a secondary embodied emotion of Athlete (“Performance”); Liberator (“Freedom”); Rescuer (“Superpowers”); Warrior (“Destruction”). The net result is a compilation of sixty embodied emotions set within a framework of twelve archetypal families and fourteen opposing needs.

The resulting Archetypal Palette of Characters is a visual representation of the spectrum of human emotional needs and how they relate to each of the archetypes.

The Archetypal Palette of Characters of FIG. 1 allows a company to identify and map their target audience's personality based on emotions they seek to evoke. This allows them to design visuals that channel emotions that appeal to the target audience. The decision as to which embodied emotion(s) to associate with a visual content item guides creativity and requires the company to focus. Companies may use multiple embodied emotions to make their stories richer and more attractive.

Given the established Archetypal Palette of Characters, the present system combines a data collection step and quantitative scoring scheme whereby brand imagery is analyzed and scored for each of the 60 “embodied emotions” of FIG. 1.

In accordance with the invention, data collection is best achieved by applying a quantitative scoring framework to each brand-related visual available to the public. Each visual is scored for each of the sixty (60) embodied emotions in the quantitative archetypal palette. Every embodied emotion is assigned an intensity value within a range of from 3 to 0 for each of the archetypes, where 3=High, 2=Medium, 1=Low, and 0=Not Present. These sixty scores are then cubed=27, 8, 1, 0, giving each piece of promotional content a value relative to each of the 60 archetypal embodied emotions.

Thus, for example, a web advertisement for a truck driven by a football star over mountainous terrain may initially score as follows:
Amazement (2)³=8
Transformation (0)³=0
Ingenuity (2)³=8
Brilliance (1)³=1
Visionary (2)³=8
Courage (3)³=27
Performance (3)³=27
Freedom (3)³=27
Superpowers (1)³=1
Guidance (3)³=27
Adventure (3)³=27
Extreme (3)³=27
Preparation (3)³=27
Challenge (3)³=27
Destruction (0)³=0
Etc.

The net result is a compilation of scores for all sixty embodied emotions set within a framework of twelve archetypal families and fourteen opposing needs.

Mass image scoring may be implemented by commercially-available third-party web crawling software capable of automatically accessing and processing webpages to understand their content such as, for example, BrightData™ or open-source Scrapy, Nutch, Mechanize, Heritrix, or the like. The mass image collection calculation step is preferably performed on every available brochure, catalog, website, social media item, etc. when there is at least one image.

All the scores for each image are added together, giving a total value per archetype. Thus, for example, the strongest archetype score for the truck advertisement would be the Explorer archetype, with a total score of 5×27=135.

All twelve archetypes are then divided into 4 categorical levels (based on their scored intensity), based on half a standard deviation below the maximum score:
High
Medium
Low
Negligible (total score less than 5%)

Thus, for example, if the standard deviation of all archetypal scores is 11.7194, half is 5.8917 and categories are assigned as follows:
High 11.7835 up
Medium 5.8918-11.7834
Low .05-5.8917
Negligible (total score less than 0.05)

Given the established archetypal palette of FIG. 1 and the above-described collection and scoring scheme, the foregoing archetypal results are then displayed through two maps: one an “executive overview” map showing only primary and secondary feelings elicited, and one a “detailed” map showing everything with each of the 60 areas coded in a grey scale to represent the different intensities.

The first overview map has the negligible archetypes removed. Levels Low and Medium are combined into a single grey value with only the High values indicated in black. Where the archetype is not present this is indicated by a white area.

The second detailed map shows all four levels (High, Medium, Low & Negligible) of intensity (when present) as %'s of black. High being solid black and Negligible being light grey. Where the archetype is not present this is indicated by a white area.

The present system builds a large database of mappings by analysis of companies/brands/visuals of different sizes from all over the world and across a wide range of industries, including both online and offline marketing communications, combining a diverse selection of creative styles and designs, and large, medium, and small budgets, from multiple sectors. A particular brand's imagery can be automatically analyzed to determine how well-aligned it is with the desired embodied emotion(s) thought to appeal to the target audience.

That particular brand imagery is auto-analyzed in accordance with the coding scheme, and the result is displayed as a brand map directly atop the feeling tone palette of FIG. 1.

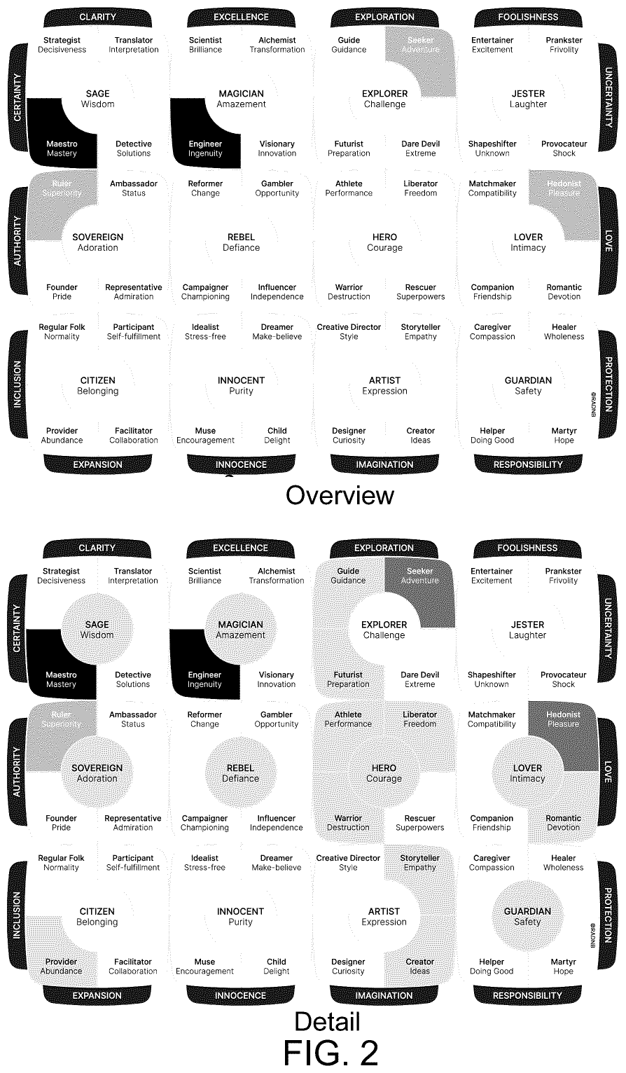

FIGS. 2-4 illustrate three exemplary brand maps each providing a visual representation of how the imagery relates to each of the feeling tones.

FIG. 2 shows a brand map for a company that seeks to project “Pride in our purpose, people, skill and ingenuity.” The Executive Overview map (top) highlights only main archetype and associated primary feeling tone elicited above a significance threshold, plus sub-archetypes and secondary embodied emotions elicited above a significance threshold. Thus, the Executive Overview Map has negligible archetypes removed, with only High values indicated in black and Levels Low and Medium combined into a single grey value. Where the archetype is not present this is indicated by a white area. In this case the result is a concentrated color map highlighting in black the primary feeling tones Mastery and Ingenuity and their respective primary archetypes Maestro and Engineer. In addition, the map highlights in grey the secondary feeling tones Superiority, Adventure and Pleasure and their respective secondary archetypes Ruler, Seeker and Hedonist.

The Detailed Map (FIG. 2 bottom) shows all feeling tones elicited (thresholds removed) and highlights everything with each of the 60 areas coded in a grey scale to represent the different intensities, no matter how significant. All four levels (High, Medium, Low & Negligible) of intensity (when present) are colorized as a percentage % of black, e.g., High being solid black and Negligible being light grey. Where the archetype is not present this is indicated by a white area. The result is a more diffuse color map highlighting, in addition to FIG. 2 (top) tertiary feeling tones such as Empathy and Ideas, as well as respective tertiary archetypes Storyteller and Creator.

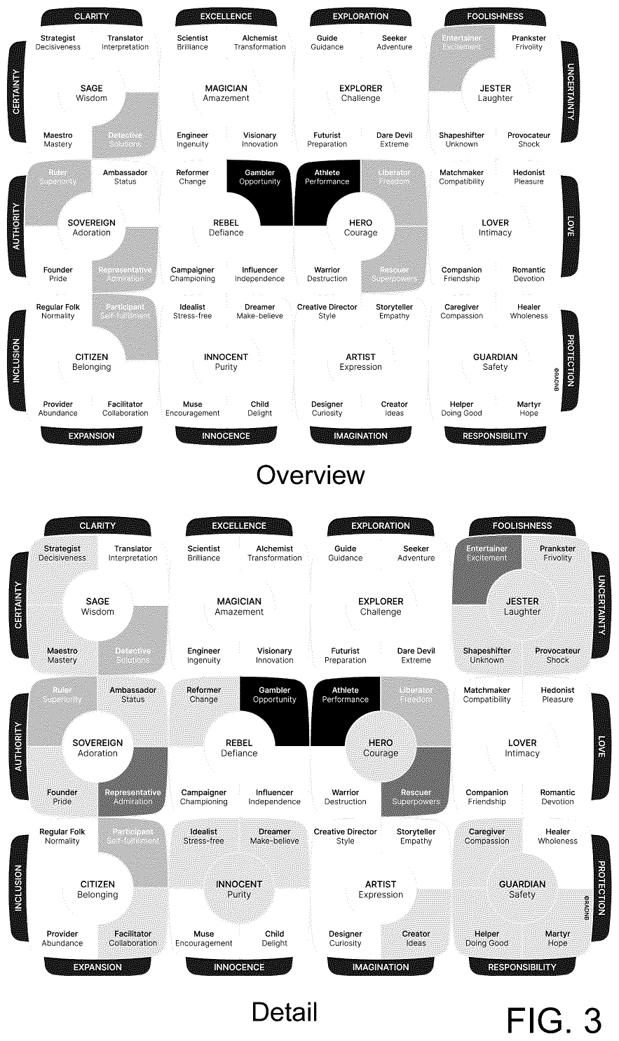

In similar manner FIG. 3 shows a brand map for a company that seeks to project “Go for it-Performance.” The Executive Overview map (top) highlights only main archetype and associated primary feeling tone elicited above a significance threshold, plus sub-archetypes and secondary embodied emotions elicited above a significance threshold. The Detailed Map FIG. 3 (bottom) shows all feeling tones elicited (thresholds removed) and highlights everything with each of the 60 areas coded in a grey scale to represent the different intensities, no matter how significant. Again, all four levels (High, Medium, Low & Negligible) of intensity (when present) are colorized as a percentage % of black, e.g., High being solid black and Negligible being light grey. Where the archetype is not present this is indicated by a white area.

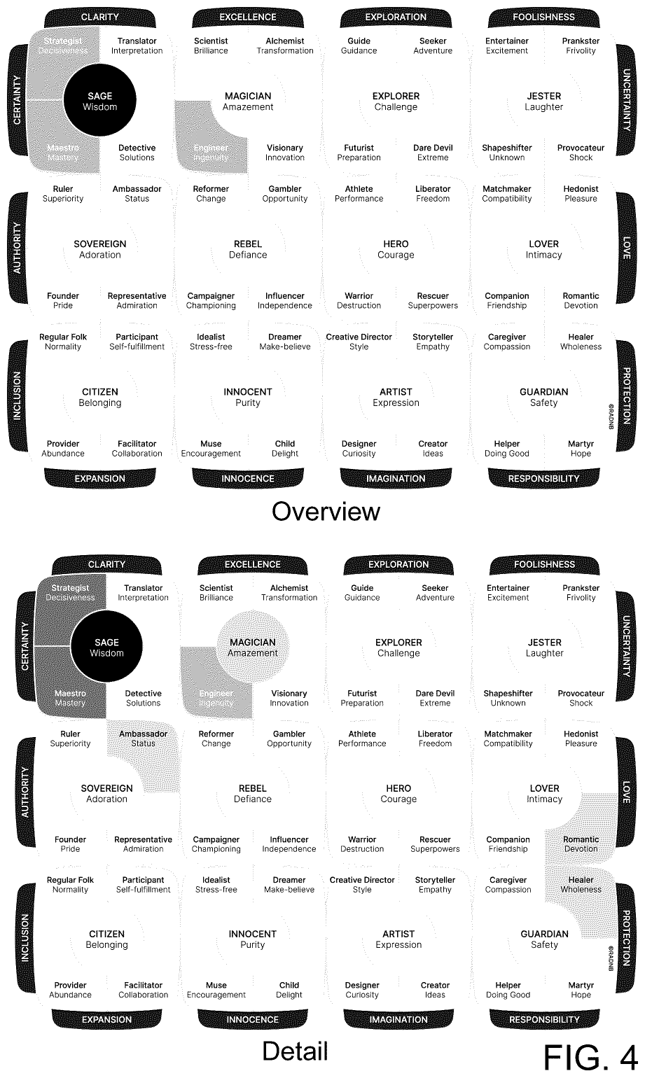

Similarly, FIG. 4 shows a brand map for a company that seeks to project “Clever, amazing, confident engineering ingenuity.” The Executive Overview map (top) highlights only main archetype and associated primary feeling tone elicited above a significance threshold, plus sub-archetypes and secondary embodied emotions elicited above a significance threshold. Thus, the Executive Overview Map has negligible archetypes removed, with only High values indicated in black and Levels Low and Medium combined into a single grey value. Where the archetype is not present this is indicated by a white area. The result is a concentrated color map highlighting the primary feeling tone Wisdom and main archetype Sage, as well as secondary feeling tones Decisiveness, Mastery and Ingenuity and their respective secondary archetypes Strategist, Maestro and Engineer. The Detailed Map (FIG. 4 bottom) shows all feeling tones elicited (thresholds removed) and highlights everything with each of the 60 areas coded in a grey scale to represent the different intensities, no matter how significant. All four levels (High, Medium, Low & Negligible) of intensity (when present) are colorized as a percentage % of black, e.g., High being solid black and Negligible being light grey. Where the archetype is not present this is indicated by a white area. The result is a more diffuse color map highlighting, in addition to FIG. 4 (top) tertiary feeling tones Amazement, Status, Devotion and Wholeness, as well as respective tertiary archetypes Magician, Ambassador, Romantic and Healer.

The comparison results identify misalignment of the brand with the embodied emotions that must appeal to a desire within your target audience. Thus, for example, if a company wants to channel “The Sage” feeling but uses brand imagery that mostly channels the “The Explorer”, the misalignment metrics can be adjusted and remediated.

The present invention also includes a mapping translation process for translating results between any personality assessment model and its visual manifestation, effectively extending the underlying mapping tool/frameworks to allow behaviors to be represented across a wide range of marketing materials. This mapping translation facilitates collection of a global database of brand metrics and applies a predictive engine to help users visually manifest their desired traits.

For example, as indicated above the Predictive Index™ measures four (4) PI personality factors, giving weight to each of the four: Dominance (the drive to exert influence on people or events); Extraversion (the drive for social interaction); Patience (the drive for consistency and stability); and Formality (the drive to conform to rules and structure). Based on the weighting each personality is assigned to one of the following Reference Profiles:

1. Analyzer: Intense with high standards and a disciplined, reserved personality.

2. Controller: Self-disciplined and fast-paced, typically straightforward, and operate within established guidelines.

3. Specialist: Highly precise worker. Skeptical while respecting authority.

4. Strategist: Big picture person who takes the long view and considers how decisions will benefit the entire organization.

5. Venturer: Self-starting, self-motivated, risk-taker with strong goal-orientation.

6. Altruist: Congenial and cooperative with an efficient, precise work ethic.

7. Captain: Problem solver who likes change and innovation while controlling the big picture.

8. Collaborator: Friendly, understanding, willing and patient team player.

9. Maverick: Innovative, outside the box thinker, undaunted by failure.

10. Guardian: natural team player, helpful, approachable, and skilled at detailed work

11. Persuader: Socially poised, risk-taker. A motivating team builder.

12. Promoter: A persuasive extravert with a tendency for informality.

13. Adapter: Bridge-builder, able to adapt to situations easily.

14. Craftsman: analytical, deliberate, meticulous: Craftsman thrive on planning, accuracy, and structure.

15. Operator: cooperative, pragmatic, stable, and thorough.

16. Individualist: persistent, results-driven mavericks, fueled by independence and low extraversion/formality.

17. Scholar: highly analytical, introspective, and independent.

Similarly, with the Taylor Meyer DiSC model there are four personality traits: Dominance (D), Influence (I), Steadiness(S), and Conscientiousness (C).
1. Dominance (D): assertive, direct, and focused on achieving results, confident, competitive, and independent.
2. Influence (I): charismatic, sociable, and optimistic, impulsive or unfocused.
3. Steadiness(S): patient, dependable, and supportive, calm, loyal, and empathetic.
4. Conscientiousness (C): analytical, detail-oriented, and systematic, precise, logical, and disciplined, rigid or perfectionistic.

The DISC model is often represented using a graph or circle that shows the relative scores of each personality trait. For example, a person with high Dominance and Influence scores might be represented as having a D and I personality blend. Each personality blend has its own strengths and weaknesses, and can be used to predict how a person is likely to behave in different situations.

In accordance with the present invention a translation cross-map is defined between Applicant's brand palette and each alternate model. To establish a cross-map every personality trait within each alternate model is assigned an intensity value from 3 to 0 for each of the archetypal embodied emotions (motivational values or needs)—High (3), Medium (2), Low (1) or Absent (0). These scores are then cubed=27, 8, 1, 0, giving each trait a value relative to each of the 60 archetypes of Applicants brand palette.

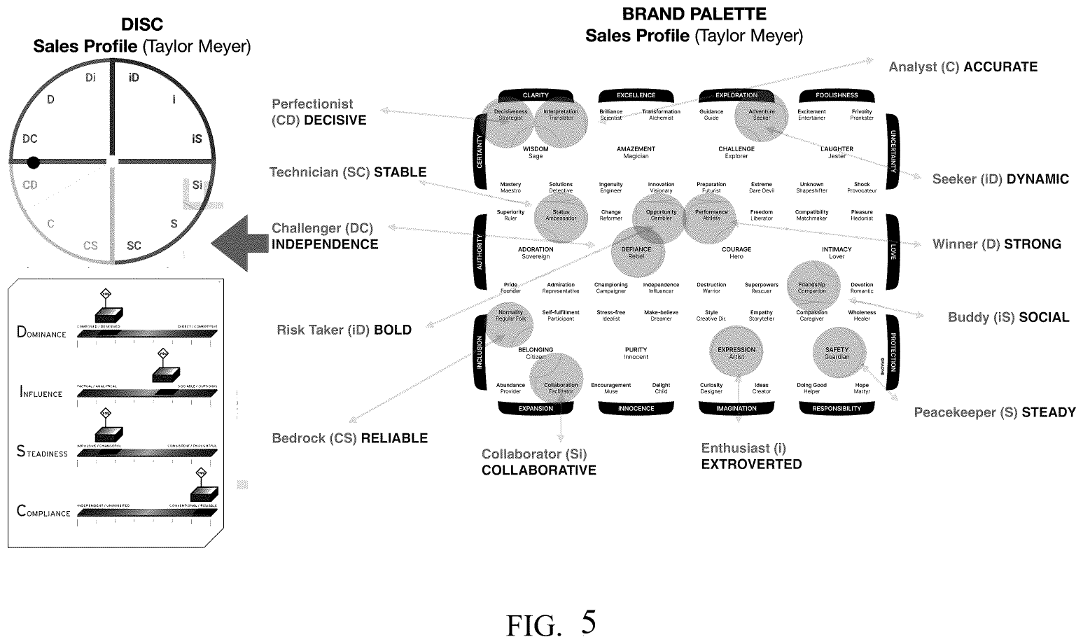

Thus, for example, as shown in FIG. 5 the DISC model is represented using a graph or circle that ranks Dominance, Influence, Steadiness and Compliance on a sliding scale as follows:
Dominance: composed/reserved (low) to direct/competitive (high);
Influence: factual/analytical (low) to social/outgoing (high);
Steadiness: impulsive/changeful (low) to consistent/thoughtful (high);
Compliance: independent/uninhibited (low) to conventional/reliable (high).

The relative scores of each personality trait can be represented as a dot (upper left) with a D and C personality blend (Dominance: assertive, direct, and focused on achieving results, confident, competitive, and independent, and Conscientiousness (C): analytical, detail-oriented, and systematic, precise, logical, and disciplined, rigid or perfectionistic). The personality blend is then categorically represented as one of sixteen (16) personality types (middle of FIG. 5). The translation process cross-map maps every personality type within the DISC model to categorical key qualities, assigns an intensity value from 3 to 0 based on the relative scores assigned in the DISC model, and maps each personality type onto the brand palette model as seen in FIG. 5 (right).

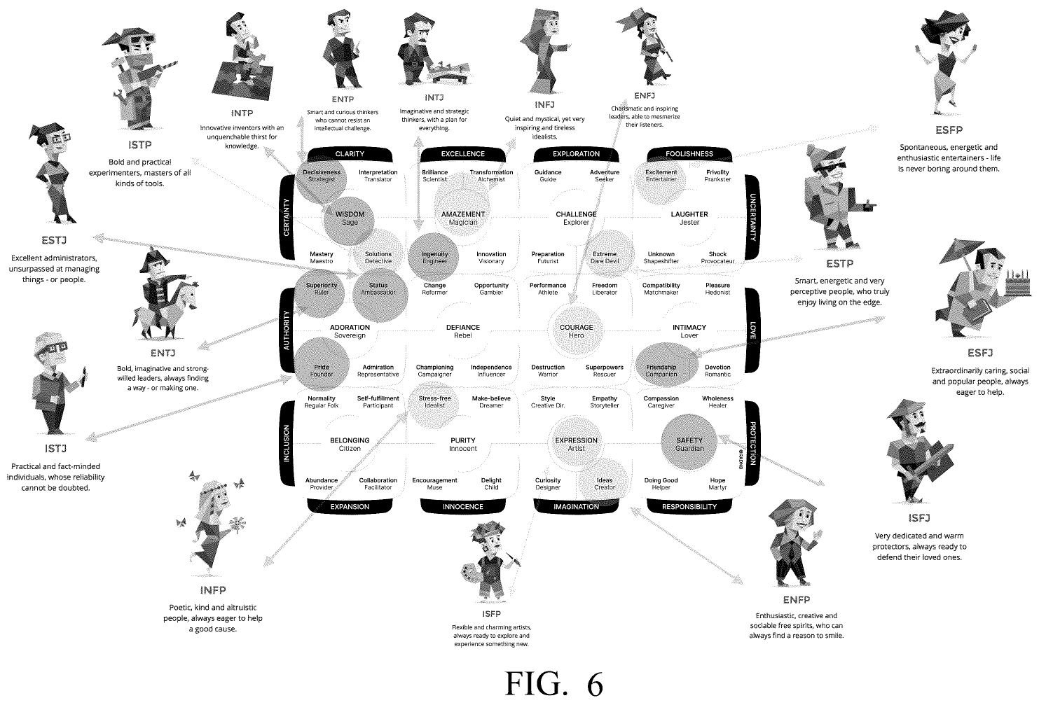

Specifically, as seen in the complete translation cross-map of FIG. 6, the process maps each DiSC personality type to the archetypes of Applicant's brand palette. Thus, for example, as seen in FIG. 6 the Architect (INTJ) is a person with the Introverted, Intuitive, Thinking, and Judging personality traits, which in turn maps to Applicant's brand palette archetypes as follows:

| DiSC | Weight | Brand Palette | Weight |
|---|---|---|---|
| composed/reserved | 3 | Strategist | 27 |
| direct/competitive | 0 | Translator | 0 |
| factual/analytical | 3 | | 27 |
| social/outgoing | 0 | Maestro | 0 |
| impulsive/changeful | 0 | Detective | 0 |
| consistent/thoughtful | 3 | Ambassador | 27 |
| independent/uninhibited | 0 | Engineer | 0 |
| conventional/reliable | 3 | Ruler | 27 |

The foregoing weighted scores map cleanly to the Engineer as shown by arrows on Applicant's brand palette as shown in FIG. 6.

Likewise, with the Predictive Index™ there are four (4) PI personality factors: Dominance (the drive to exert influence on people or events); Extraversion (the drive for social interaction); Patience (the drive for consistency and stability); and Formality (the drive to conform to rules and structure). Personalities are assigned to one of seventeen (17) Reference Profiles based on the weighted personality factors.
Analyzer
Controller
Venturer
Specialist
Strategist
Altruist
Captain
Collaborator
Maverick
Promoter
Persuader
Adapter
Artisan
Guardian
Operator
Individualist
Scholar

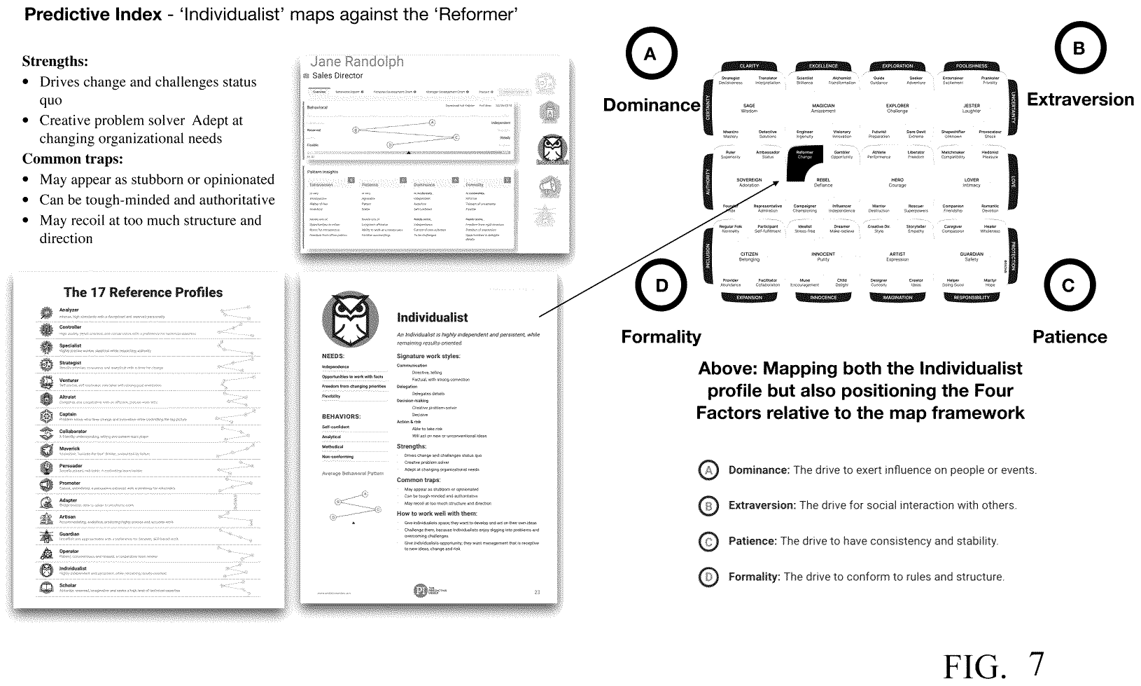

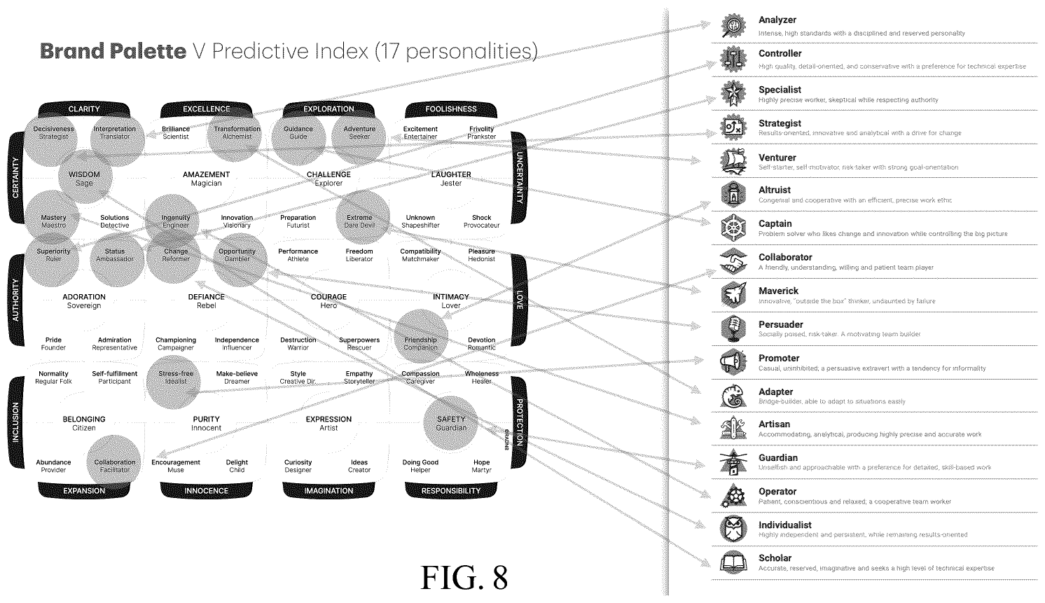

As shown in FIG. 8 the translation cross-map maps each of the seventeen (17) Reference Profiles to a corresponding archetype in Applicant's brand palette. In addition, the four (4) PI personality factors are mapped to categorical key qualities, and assigned an intensity value from 3 to 0 based on the relative scores assigned in Predictive Index model. Thus, FIG. 7 maps the PI Individualist Profile directly to Brand Palette Reformer, and also maps Four Factors relative to the map framework using an Average Behavioral Pattern as shown. The translation cross-map then maps every weighted categorical key quality. Thus, for example, as seen in FIG. 7 weighted Dominance (D) and Extraversion (E) map to the following intermediate key qualities and weights, which in turn maps to Applicant's brand palette archetypes as follows:

| PI | Key Qualities | | Brand Palette | Weight |
|---|---|---|---|---|
| Individualist | Self-Confident | 1 | Strategist | 1 |
| | Analytical | 1 | Translator | 1 |
| | Methodical | 1 | Maestro | 1 |
| | Non-conforming | 2 | Reformer | 64 |

The net result is a compilation of scores for all sixty embodied emotions set within a framework of twelve archetypal families and fourteen opposing needs.

While there is no common language for each human profiling, the traits within said human profiling models correlate with the Brand Palette framework. One skilled in the art will readily understand that the above-described mapping translation process can be applied to any personality assessment model, and effectively extend the underlying mapping tool/framework of Brand Palette to visually manifest personality rights and behaviors discovered by personality profiling tools in a wide range of marketing applications.

The above-described embodiment is for the purpose of promoting an understanding of the principles of the invention. It should nevertheless be understood that no limitation of the scope of the invention is thereby intended, such alternations and further modifications in the illustrated device, and such further applications of the principles of the invention as illustrated herein being contemplated as would normally occur to one skilled in the art to which the invention relates.

We claim:

1. A method for mapping brand imagery comprising the steps of:
establishing an archetypal palette comprising a matrix array of a plurality of psychological archetypes each associated with a plurality of embodied emotions;
scoring each of said embodied emotions in a brand-related visual image by analyzing said image, scoring each of said embodied emotions in said visual image, and assigning a quantitative intensity value thereto;
summing all the embodied emotion scores for said visual advertisement to yield a total value for each of said plurality of psychological archetypes.

2. The method of claim 1, further comprising a step of graphically illustrating the intensity values assigned to all of said embodied emotions on said archetypal palette.

3. The method of claim 1, further comprising a step of establishing a quantitative scoring framework.

4. The method of claim 1, wherein said step of establishing an archetypal palette comprises establishing an archetypal palette of characters configured to identify and map embodied emotions sought to be evoked.

5. The method of claim 1, wherein said brand-related visual image comprises any one from among the group consisting of a brochure, catalog, website, and social media post.

6. The method of claim 5, wherein said step of scoring each of said embodied emotions comprises analyzing said brand-related visual image, assigning an intensity score for each of said embodied emotions based on the strength by which said brand-related visual image evokes said embodied emotion.

7. The method of claim 6, wherein said step of scoring each of said embodied emotions further comprises multiplying each assigned intensity score for each of said embodied emotions by a multiplier.

8. The method of claim 7, wherein said step of graphically illustrating the multiplied intensity values assigned to all of said embodied emotions comprises color-mapping onto said archetypal palette.

9. The method of claim 1, further comprising a step of compiling a translation cross-map of each of said embodied emotion scores to a different personality assessment model.

10. The method of claim 9, further comprising a step of cross-mapping every embodied emotion score to said different personality assessment model using said translation cross-map.

11. A computer method for mapping brand imagery comprising the steps of:
establishing an archetypal palette of characters configured to identify and map embodied emotions sought to be evoked;
assigning a range of discrete intensity values to each embodied emotion of each character of the archetypal palette of characters;
scoring an instance of visual promotional content by assigning a discrete intensity value to each embodied emotion representing tendency of said visual promotional content to elicit each such embodied emotion;
calculating total scores attributable to each embodied emotion for each character of said archetypal palette of characters;
mapping the total scores into a visual map that ranks characters within the archetypal palette of characters that are primarily motivated by the instance of visual promotional content.

12. The method of claim 11, wherein said calculating step further comprises weighting each assigned discrete intensity value.

13. The method of claim 12, wherein said calculating step further comprises categorizing each calculated total scores attributable to each embodied emotion for each character of said archetypal palette of characters.

14. A method for translating personality traits from a personality assessment model to an archetypal palette of characters comprising a matrix array of a plurality of psychological archetypes each associated with a plurality of embodied emotions, comprising the steps of:
compiling a translation cross-map of a plurality of personality traits within said first personality assessment model to each of said plurality of embodied emotions within said archetypal palette of characters; and
cross-mapping every weighted personality trait from said first personality assessment model to said archetypal palette of characters using said translation cross-map;
mapping brand imagery by the substeps of,
establishing an archetypal palette comprising a matrix array of a plurality of psychological archetypes each associated with a plurality of embodied emotions,
scoring each of said embodied emotions in a brand-related visual image by analyzing said image, scoring each of said embodied emotions in said visual image, and assigning a quantitative intensity value thereto, and
summing all the embodied emotion scores for said visual advertisement to yield a total value for each of said plurality of psychological archetypes.

15. The method of claim 14, wherein said personality scores from said first personality assessment model comprise an intensity value for each of a plurality of embodied emotions.

16. The method of claim 15, wherein said step of compiling a translation cross-map comprises assigning a weighting factor to every intensity value for each of a plurality of embodied emotions.

17. The method of claim 15, further comprising a step of scoring a brand-related visual image by analyzing said image, scoring each of said embodied emotions in said visual image, and assigning a quantitative intensity value thereto.

18. The method of claim 17, further comprising a step of summing all the embodied emotion scores for said visual image to yield a total value for each character in said plurality of archetypal palette of characters.

19. A computer method for mapping personality traits and behaviors discovered by a personality assessment model to an effective visual manifestation comprising the steps of:
compiling a translation cross-map of every personality trait within said first personality assessment model to categorical key qualities of Brand Palette Framework, and assigning intensity values;
cross-mapping every weighted personality trait to said categorical key qualities; and cross-mapping every weighted categorical key quality to a visual manifestation/mood board.
